(19) United States
(12) Patent Application Publication
(10) Pub. No.: US 2014/0077642 A1
(43) Pub. Date: Mar. 20, 2014

(54) Motor Stator Assembly

(71) Applicant: Sunonwealth Electric Machine Industry Co., Ltd., Kaohsiung (TW)

(72) Inventor: Shih-Chang Huang, Kaohsiung (TW)

(73) Assignee: Sunonwealth Electric Machine Industry Co., Ltd., Kaohsiung (TW)

(21) Appl. No.: 13/896,433

(22) Filed: May 17, 2013

(30) Foreign Application Priority Data
Sep. 19, 2012 (TW) 101134361

(51) Int. Cl. H02K 5/10

(52) U.S. Cl. CPC H02K 5/10
USPC 310/86

(57) ABSTRACT

A motor stator assembly includes an iron core, a coil unit and a dustproof ring. The coil unit is coupled with the iron core. The iron core is spaced from a predetermined part of the coil unit by a gap when coupled with the coil unit. The dustproof ring is fitted around the predetermined part of the coil unit to cover the gap between the iron core and the predetermined part of the coil unit.

### BACKGROUND OF THE INVENTION

1. Field of the Invention

The present invention generally relates to a motor stator assembly and, more particularly, to a motor stator assembly that can be installed in a motor or a cooling fan.

2. Description of the Related Art

A conventional motor stator assembly generally consists of a plurality of silicon steel plates that is stacked one after another to form an iron core. An enamel copper wire is wound around a predetermined part of the iron core to form a coil unit. The conventional motor stator assembly may be installed in a cooling fan (or a motor) to drive an impeller of the cooling fan (or a rotor of the motor) to rotate.

Referring to FIG. 1, Taiwan Patent No. 579142 discloses a motor stator assembly 9 having an iron core 91 that is formed by a plurality of silicon steel plates stacked together. A coil unit 92 is arranged on the iron core 91. The motor stator assembly 9 further comprises two coil covers 93 adapted to cover the coil unit 92, positioning the coil unit 92 inside the coil covers 93. Furthermore, each coil cover 93 is integrally formed with an insulation material.

Although the coil covers 93 are able to cover the coil unit 92, the coil covers 93 are not able to completely cover the gaps D between the iron core 91 and the coil unit 92. As a result, dust may intrude into the motor stator assembly 9 via the gaps D when the motor stator assembly 9 is installed in a cooling fan or a motor, leading to an accumulation of dust inside the motor stator assembly 9. Consequently, the motor stator assembly 9 may not be able to operate normally.

### SUMMARY OF THE INVENTION

It is therefore the objective of this invention to provide a motor stator assembly capable of efficiently preventing the dust from intruding into the motor stator assembly via a gap between an iron core and a coil unit, ensuring the normal operation of the motor stator assembly.

In one embodiment, a motor stator assembly including an iron core, a coil unit and a dustproof ring is disclosed. The coil unit is coupled with the iron core. The iron core is spaced from a predetermined part of the coil unit by a gap when coupled with the coil unit. The dustproof ring is fitted around the predetermined part of the coil unit to cover the gap between the iron core and the predetermined part of the coil unit.

In a preferred form shown, the iron core has an inner peripheral face forming a receiving hole, as well as a plurality of magnetic-induction portions formed on the inner peripheral face of the iron hole. The receiving hole extends in an axial direction of the iron core. A wire path is formed between each two adjacent magnetic-induction portions. The coil unit is in the form of an enamel copper wire partially extending in the wire paths between the plurality of magnetic-induction portions.

In the preferred form shown, the coil unit comprises an excitation portion and a binding portion. The excitation portion is the part of the enamel copper wire extending in the wire paths. The binding portion is the other part of the enamel copper wire that is bound together outside the receiving hole.

In the preferred form shown, the predetermined part of the coil unit is the binding portion, and the gap is located between the iron core and the binding portion of the coil unit.

In the preferred form shown, the iron core has an inner peripheral face forming a receiving hole, as well as a plurality of magnetic-induction portions extending outwards from an outer face of the iron core in a radial direction of the iron core. The coil unit is arranged on the plurality of magnetic-induction portions.

In the preferred form shown, the dustproof ring is elastic. The dustproof ring is made of rubber or silicon gel.

In the preferred form shown, the dustproof ring comprises two openings at two sides thereof. One of the openings faces the iron core. The coil unit is located within an extent of the other opening.

In the preferred form shown, the iron core comprises two faces spaced from each other in the axial direction of the iron core. Each of the two faces of the iron core is provided with an insulation member. The coil unit is coupled with the iron core via the insulation members.

In the preferred form shown, the insulation member is spaced from the predetermined part of the coil unit by the gap when the iron core is coupled with the coil unit, and the dustproof ring is fitted around the predetermined part of the coil unit to cover the gap between the insulation member and the predetermined part of the coil unit.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a cross-sectional view of a conventional motor stator assembly.

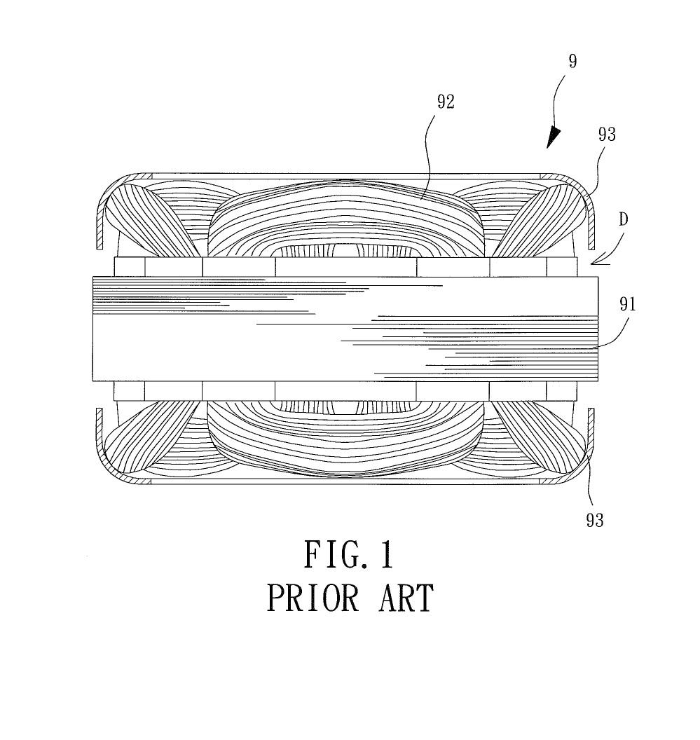

FIG. 2 is an exploded view of a motor stator assembly according to a first embodiment of the invention.

FIG. 3 is a cross-sectional view of the motor stator assembly according to the first embodiment of the invention.

FIG. 4 is a cross-sectional view of a cooling fan equipped with the motor stator assembly of the first embodiment of the invention.

FIG. 5 is an exploded view of a motor stator assembly according to a second embodiment of the invention.

FIG. 6 shows the motor stator assembly of the second embodiment of the invention.

In the various figures of the drawings, the same numerals designate the same or similar parts. Furthermore, when the terms “first”, “second”, “third”, “fourth”, “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

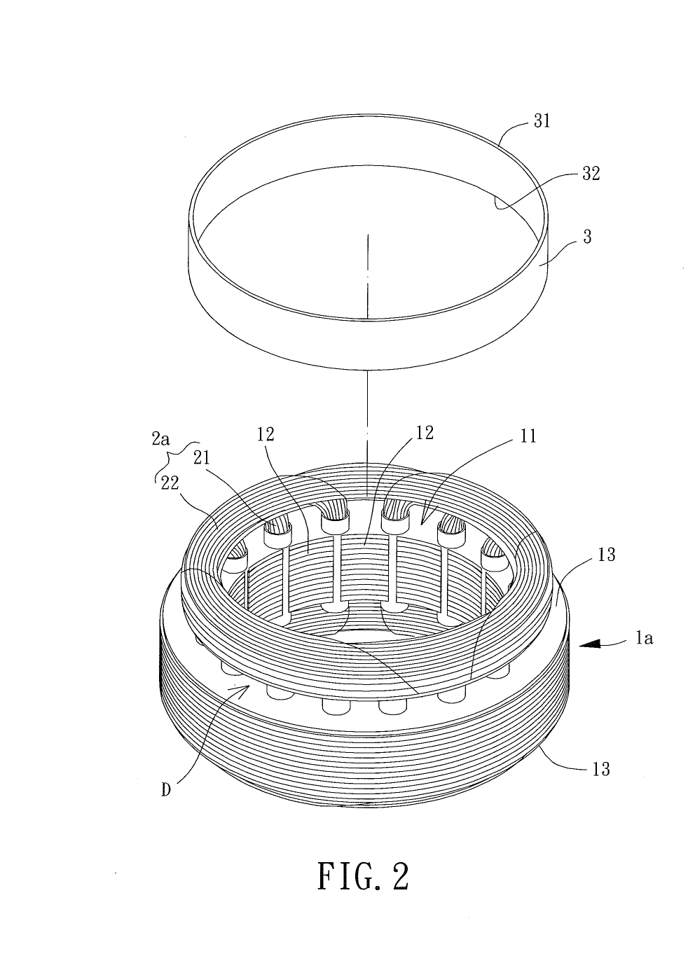

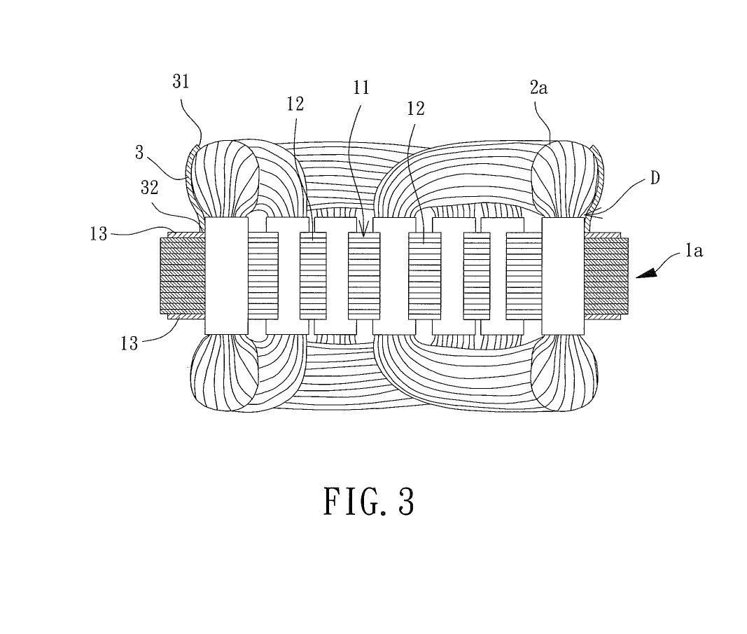

The motor stator assembly in one embodiment of the invention may be used to construct an inner-rotor motor or an outer-rotor motor. Referring to the inner-rotor motor shown in FIGS. 2 and 3 according to a first embodiment of the invention, the motor stator assembly comprises at least an iron core 1a, a coil unit 2a and a dustproof ring 3. The coil unit 2a may be wound around the iron core 1a. The dustproof ring 3 may be fitted around the coil unit 2a (namely, the dustproof ring 3 is fitted around an outer peripheral face of the coil unit 2a).

The iron core 1a may be integrally formed into a predetermined shape by powder metallurgy, molding, punching or the like. Alternatively, the iron core 1a may be formed by a plurality of silicon steel plates stacked together. The iron core 1a has an inner peripheral face forming a receiving hole 11 extending in an axial direction thereof, as well as a plurality of magnetic-induction portions 12 located on the inner peripheral face of the iron core 1a.

In the first embodiment, the iron core 1a is formed by a plurality of silicon steel plates stacked together. Each silicon steel plate has an inner periphery forming a through-hole extending through the silicon steel plate in the axial direction. A magnetic pole end is arranged on the inner periphery of each silicon steel plate. Thus, when the silicon steel plates are stacked together to form the iron core 1a, the through-holes of the silicon steel plates may jointly form the receiving hole 11. The magnetic pole ends of the stacking silicon steel plates form the magnetic-induction portions 12 received in the receiving hole 11. Moreover, the iron core 1a may have two faces spaced from each other in the axial direction. An insulation member 13 is preferably arranged on each face of the iron core 1a to prevent the contact between the coil unit 2a and the iron core 1a after the coil unit 2a is coupled with the iron core 1a. Therefore, short circuit between the coil unit 2a and the iron core 1a can be prevented.

A wire path is formed between each two adjacent magnetic-induction portions 12. The coil unit 2a is coupled with the iron core 1a, and the enamel copper wire of the coil unit 2a partially extends in the wire paths between the magnetic-induction portions 12. The iron core 1a is spaced from a predetermined part of the coil unit 2a by a gap (D). In this embodiment, the coil unit 2a comprises an excitation portion 21 and a binding portion 22. The excitation portion 21 of the coil unit 2a is the part of the enamel copper wire extending in the wire paths between the magnetic-induction portions 12. The binding portion 22 of the coil unit 2a is the other part of the enamel copper wire that is bound together outside the receiving hole 11. The predetermined part of the coil unit 2a is the binding portion 22 thereof. The gap (D) is located between the binding portion 22 of the coil unit 2a and the iron core 1a. Specifically, if the insulation member 13 is arranged, the gap (D) is located between the binding portion 22 of the coil unit 2a and the insulation member 13.

The dustproof ring 3 has two openings 31 and 32 at two sides thereof. The openings 31 and 32 allow the dustproof ring 3 to be fitted around the coil unit 2a to cover the gap (D) between the binding portion 22 of the coil unit 2a and the iron core 1a. Advantageously, the dust is no longer able to intrude into the iron core 1a via the gap (D). In this embodiment, the dustproof ring 3 is preferably in the form of a ring with elasticity as shown in FIG. 3. The ring may be made of rubber or silicon gel, for example. The elasticity of the dustproof ring 3 allows the dustproof ring 3 to be fitted around different sizes of iron cores. In addition, when the dustproof ring 3 is fitted around the coil unit 2a to cover the gap (D), the coil unit 2a may protrude from the opening 31 of the dustproof ring 3.

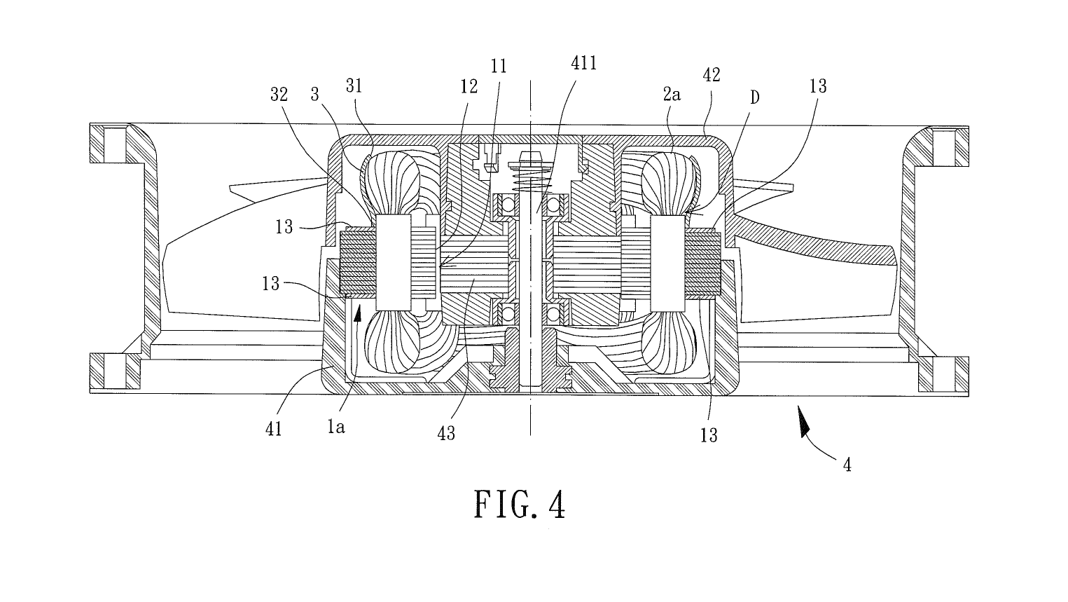

FIG. 4 is a cross-sectional view of a cooling fan 4 equipped with the motor stator assembly. The cooling fan 4 comprises a frame base 41. The iron core 1a is mounted on the frame base 41. The frame base 41 comprises a shaft 411 with which an impeller 42 is rotatably coupled. A magnetic-conducting member 43 is installed in the impeller 42. The magnetic-conducting member 43 is received in the receiving hole 11 of the iron core 1a and faces the magnetic-induction portions 12. In this arrangement, the impeller 42 can be driven to rotate when the motor stator assembly is electrified, providing a cooling effect. Alternatively, the motor stator assembly in this embodiment can also be installed in a motor. The detailed structures and operations of the motor and the cooling fan are not described herein, as it would be readily appreciated by one having ordinary skill in the art.

The opening 32 of the dustproof ring 3 may face the iron core 1a while the other opening 31 allows for exposure of the coil unit 2a. In other words, the coil unit 2a is located within an extent of the opening 31 to allow for exposure of the coil unit 2a. In this manner, the dustproof ring 3 may be able to cover the gap (D) between the coil unit 2a and the iron core 1a. When the motor stator assembly is installed in a cooling fan or a motor, since the impeller 42 is able to cover the motor stator assembly from the above (see FIG. 4), it can prevent the dust from intruding into the motor stator assembly via the gap (D) above the motor stator assembly. Thus, reduced service life and increased noise of the motor can be prevented. Therefore, the technique concept in the embodiment is to provide the motor stator assembly with an improved dustproof effect via the dustproof ring 3 fitted around the coil unit 2a.

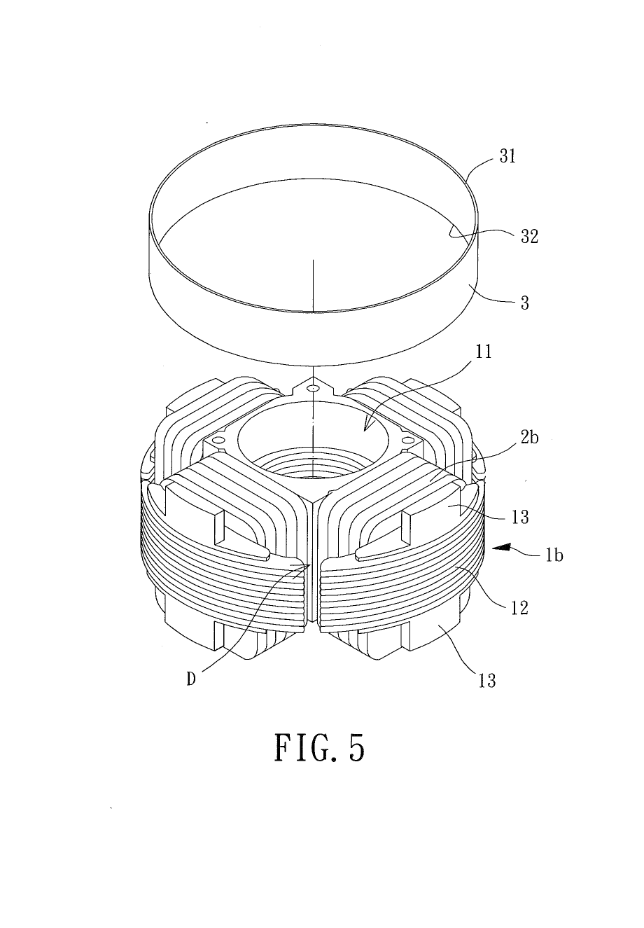

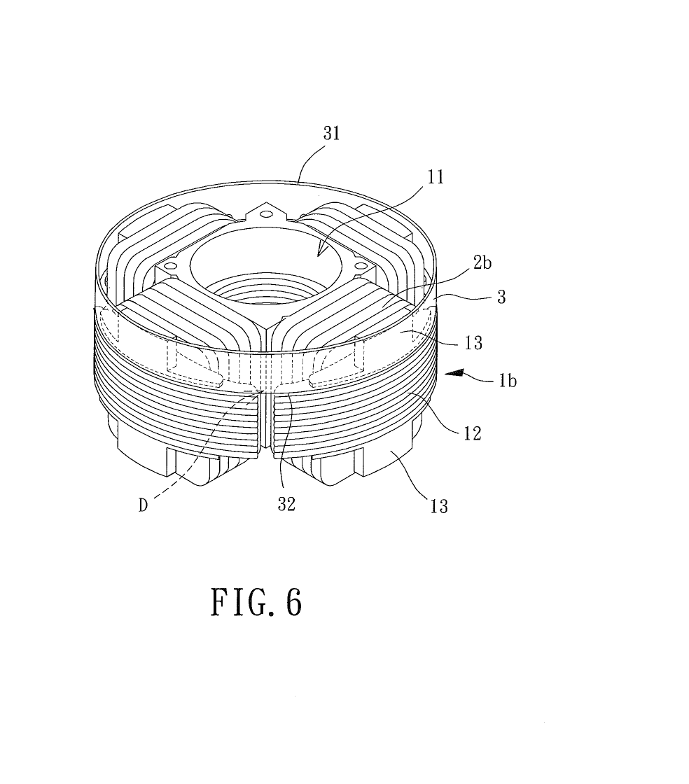

FIGS. 5 and 6 show a motor stator assembly of an outer-rotor motor according to a second embodiment of the invention. The motor stator assembly comprises at least an iron core 1b, a coil unit 2b and a dustproof ring 3. An enamel copper wire is wound around the iron core 1b to form the coil unit 2b. The dustproof ring 3 is adapted to fit around the coil unit 2b.

Similar to the iron core 1a, the iron core 1b may be integrally formed into a predetermined shape by powder metallurgy, molding, punching or the like. Alternatively, the iron core 1b may also be formed by a plurality of silicon steel plates stacked together. The iron core 1b has an inner peripheral face forming a receiving hole 11 extending in an axial direction thereof, as well as a plurality of magnetic-induction portions 12 located on an outer face of the iron core 1b.

In this embodiment, the iron core 1b is formed by a plurality of silicon steel plates stacked together. Each silicon steel plate has an inner periphery forming a through-hole extending through the silicon steel plate in the axial direction. A magnetic pole end is arranged on an outer periphery of each silicon steel plate. Thus, when the silicon steel plates are stacked together to form the iron core 1b, the through-holes of the silicon steel plates may jointly form the receiving hole 11 while the magnetic pole ends of the silicon steel plates are aligned in the axial direction to form the magnetic-induction portions 12. Moreover, the iron core 1b may have two faces spaced from each other in the axial direction. Each face of the iron core 1b is provide with an insulation member 13 to prevent the contact between the coil unit 2b and the iron core 1b after the coil unit 2b is coupled with the iron core 1b. Therefore, short circuit between the coil unit 2b and the iron core 1b can be prevented.

The coil unit 2b is coupled with the iron core 1b, and the enamel copper wire of the coil unit 2b is wound around the iron core 1b. Alternatively, when the insulation members 13 are arranged on the iron core 1b, the enamel copper wire of the coil unit 2b is indirectly wound around the magnetic-induction portions 12 via the insulation members 13. The iron core 1b is also spaced from a predetermined part of the coil unit 2b by a gap (D).

The dustproof ring 3 has two openings 31 and 32 at two sides thereof. The openings 31 and 32 allow the dustproof ring 3 to be fitted around the coil unit 2b. Thus, the dustproof ring 3 is able to cover the gap (D). Advantageously, the dust is no longer able to intrude into the iron core 1b via the gap (D). When the insulation members 13 are arranged on the iron core 1b, the dustproof ring 3 is fitted around the outer peripheral faces of the insulation members 13 to effectively cover the gap (D) between the coil unit 2b and the iron core 1b.

It can be recognized from the above description that the dustproof ring 3 is able to cover the gap (D) between the coil unit 2a and the iron core 1a (as well as the gap (D) between the coil unit 2b and the iron core 1b). Thus, when the motor stator assembly is installed in a cooling fan or a motor, it can effectively prevent the dust from intruding into the motor stator assembly via the gap (D). Thus, the normal operation of the motor stator assembly can be ensured after the motor stator assembly operates for a long duration of time, prolonging the service life of the motor stator assembly.

Furthermore, since the dustproof ring 3 is elastic, the dustproof ring 3 can be easily coupled with various iron cores with different sizes. Moreover, although the size and shape of the gap (D) between the coil unit 2a and the iron core 1a change, the elasticity of the dustproof ring 3 will allow the dustproof ring 3 to effectively cover the gap (D), providing an improved covering function therefor. Thus, it omits the need in preparing different dustproof rings 3 for different sizes of the iron cores while providing a convenient assembly and an improved covering effect.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A motor stator assembly comprising:
an iron core;
a coil unit coupled with the iron core, wherein the iron core is spaced from a predetermined part of the coil unit by a gap when coupled with the coil unit; and
a dustproof ring fitted around the predetermined part of the coil unit to cover the gap between the iron core and the predetermined part of the coil unit.

2. The motor stator assembly as claimed in claim 1, wherein the iron core has an inner peripheral face forming a receiving hole, as well as a plurality of magnetic-induction portions formed on the inner peripheral face of the iron core, wherein the receiving hole extends in an axial direction of the iron core, wherein a wire path is formed between each two adjacent magnetic-induction portions, and wherein the coil unit is in the form of an enamel copper wire partially extending in the wire paths between the plurality of magnetic-induction portions.

3. The motor stator assembly as claimed in claim 2, wherein the coil unit comprises an excitation portion and a binding portion, wherein the excitation portion is the part of the enamel copper wire extending in the wire paths, and wherein the binding portion is an other part of the enamel copper wire that is bound together outside the receiving hole.

4. The motor stator assembly as claimed in claim 3, wherein the predetermined part of the coil unit is the binding portion, and wherein the gap is located between the iron core and the binding portion of the coil unit.

5. The motor stator assembly as claimed in claim 1, wherein the iron core has an inner peripheral face forming a receiving hole, as well as a plurality of magnetic-induction portions located on an outer face of the iron core, wherein the receiving hole extends in an axial direction of the iron core, and wherein the coil unit is arranged on the iron core.

6. The motor stator assembly as claimed in claim 1, wherein the dustproof ring is elastic.

7. The motor stator assembly as claimed in claim 6, wherein the dustproof ring is made of rubber or silicon gel.

8. The motor stator assembly as claimed in claim 1, wherein the dustproof ring comprises two openings at two sides thereof, wherein one of the two openings faces the iron core, and wherein the coil unit is located within an extent of the other one of the two openings.

9. The motor stator assembly as claimed in claim 2, wherein the iron core comprises two faces spaced from each other in the axial direction, wherein each of the two faces of the iron core is provided with an insulation member, and wherein the coil unit is coupled with the iron core via the insulation members.

10. The motor stator assembly as claimed in claim 9, wherein the insulation member is spaced from the predetermined part of the coil unit by the gap when the iron core is coupled with the coil unit, and wherein the dustproof ring is fitted around the predetermined part of the coil unit to cover the gap between the insulation member and the predetermined part of the coil unit.
